(19) United States
(12) Patent Application Publication
(10) Pub. No.: US 2004/0011598 A1
(43) Pub. Date: Jan. 22, 2004

(54) Bicycle brake device

(76) Inventors: Frank Hermansen, Laguna Beach, CA (US); Carl Winefordner, Laguna Beach, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/196,031

(22) Filed: Jul. 16, 2002

(51) Int. Cl. B62L 3/00

(52) U.S. Cl. 188/24.21

(57) ABSTRACT

A bicycle brake device which has extremely small brake pads, relatively hard pad rubber, and a tool-free pad adjustment mechanism that allows the rider to periodically extend the pad as it wears. Partially because of the small pad size, the brake can be designed to be very powerful, and simplify initial installation and adjustment. The bicycle rim brake has fewer degrees of freedom of adjustment in order to simplify installation and maintenance. The preferred embodiment can have only four degrees of freedom because the pad surface is so small that a pad rotation adjustment and pad orientation adjustment are unnecessary. The present invention allows the user to easily extend the pads to their original preferred position without tools. This not only keeps the brake pad surface at the correct position relative to the rim, but also keeps the brake hand levers in the preferred position.

### BACKGROUND OF THE INVENTION

1. Field of the Invention

The present invention is directed to braking devices for bicycles and, more particularly, to a brake device which is supported by fastening pins extending from seats installed on the front fork or rear fork of a bicycle, and which is driven by a brake wire so that brake pads are pressed against the rim of the corresponding wheel.

2. Background Art

In the case of bicycles which allow off-road riding (known as mountain bikes (MTB) or all-terrain bikes (ATB)), cantilever type brake mechanisms are generally mounted on the bicycles in order to provide a strong braking force. One end of each of the brake arms is supported on the front fork or rear fork so that the end is free to pivot, while the other end of each brake arm is connected to the brake wire. The brake pads are installed on intermediate portions of the brake arms so that the brake pads face both side surfaces of the bicycle wheel rim.

In such a cantilever type bicycle brake mechanism, the brake arms are caused to pivot in the closing direction by using a brake lever to pull the brake wire. As a result, the brake pads are pressed against the aforementioned rim so that braking is applied. Such a cantilever type brake mechanism offers many advantages. For example, there is no need to alter the shape of the brake mechanism in accordance with the size of the bicycle (as is necessary in the case of caliper brake mechanisms). Furthermore, braking force tends to be much more even than with caliper brake mechanisms.

Unfortunately, prior art rim brake mechanisms suffer from problems of their own. For example, setup during initial installation is especially difficult because the brake pad has many degrees of freedom of movement. Typically, the brake pad holder has a threaded stem and two pairs of conical spacers. This allows the pad holder to twist 360 degrees and be angled in any direction. The twisting is necessary in order to align the long brake pads. The brake pad holder stem can also typically move up and down within a slot on the brake arm. Typical prior art rim brakes have at least six degrees of freedom (arm angle via cable clamp, up/down, pad angle, pad rotation, pad orientation, pad in/out with spacers). In typical prior art rim brakes, setup is difficult and it is nearly impossible to adjust both sides of the brake equally because typical prior art rim brakes have multiple adjustments that must occur simultaneously. This array of adjustment is necessary, in part, because of variances in the positions of the fastening pins on the front and rear forks of the bicycle relative to the wheel rim.

Prior art rim brakes have a tendency to squeal if they are not properly adjusted. The cause of the squealing is the pad holder vibrating. Normally, the pad must be slightly “toed in” in order to prevent the vibration. The vibration is exacerbated on longer brake pads. In other words, the longer the pad, the more likely that the brake is to squeal. After the initial installation, the brakes must be tested for squealing and then readjusted as necessary.

During use, the pad slowly wears. As it wears, the brake arms swing inward. As this occurs, the pad changes vertical position. Note that this is true even with most parallel push brakes. As the pad wears, the bottom edge will begin to not fully contact the rim (the bottom will begin to miss). This causes the bottom edge of the pad to not wear evenly with the rest of the pad, which can cause the bottom edge to rub against the rim if the brake is adjusted inwards by simply tightening the brake cable. Adjusting the pads to the new correct position can be as difficult as the original setup during initial installation.

Prior art rim brake pads are long and narrow and shallow and have a large contact area. In order to reduce weight and profile of the brake, and in order to reduce alignment problems as the pad wears, modem pads have a relatively small amount of rubber beyond the lip of the pad holder. As the brake pad wears, the pad holder becomes closer and closer to the wheel rim. When the distance is relatively small, it is time to change the pad. For example, the distance from the lip of the pad holder to the braking surface of the pad on a new pad is typically about 4 mm. When the pad is worn enough that the distance is only around 1 or 2 mm, then most riders will change to a new pad to not risk damaging their wheel rim. Also, there is typically about 3 mm of rubber below the pad holder lip, which is used for retaining the pad to the pad holder. That means that out of a pad, which is 7 mm thick, only 2 or 3 mm is actually used. Therefore, the useful volume of the pad material is only about 30 to 40% of the total rubber volume. When the pads are changed, 60 to 70% of the rubber is discarded.

Because the pads are made from relatively soft rubber, the pads wear out relatively fast. Certain types of riding conditions, such as exposure to mud, cause pads to wear even more quickly because the rim becomes coated in abrasive materials. The pad must be relatively soft because the hardness is limited by the fact that the pad braking surface is relatively large. For the rubber to cause high braking friction, the force per unit area must be high enough and the harder the rubber, the higher the required force per unit area to achieve powerful braking.

Tools are required for replacing the brake pads on prior art rim brakes. For some designs, the pad holder and pad are one unit and usually a hex wrench or box wrench is required to remove the originals and install the new ones. In those cases, replacing the pads is as difficult as the initial brake installation. Even with modern brakes that have pad holders that allow old pads to slide out and new ones to slide in, there is a cotter pin or similar device that must be removed and reinstalled. The cotter pin keeps the pad from inadvertently sliding out if the brakes are applied when backing up. A needle nose pliers or the like is required to pull out the cotter pin. Another problem is that during a pad change, it is very easy to drop and lose the very small cotter pin.

Many prior art bicycle rim brakes have pad holders that allow new rubber pads to be installed without removing the pad holder from the brake arm. Generally, the pads are slid into the pad holder from one end and then a cotter pin keeps the pad from sliding back out in the event of braking while backing up. The pin would not, however, be enough to retain the pad under hard braking. For that reason, brakes with replaceable pads are sold as either front or rear brakes, depending on how the pad holders are assembled. This requires manufacturers, distributors, and retailers to carry a higher level of inventory because there are two brake models instead of one. Also, it creates a risk that consumers will install the brakes improperly. If the front brake is installed on the rear of the bike (or vice versa), there would be a dangerous situation because the pads could slide out during hard braking.

There are many reasons that a rider needs to remove the wheel from the bicycle such as for repairing a punctured tube or replacing a tire or transporting the bicycle. In order to remove the wheel, the cable is normally disengaged from the brake so that the brake arms can be pivoted out of the way. Prior art pads are so big that the amount they open is limited because the pad holders contact the bicycle fork and this prevents the brake from fully opening which interferes with tire removal and installation. Because of this, removing and installing the wheel is much more difficult, especially if it has a relatively wide tire that is still inflated.

Prior art rim brakes typically lose a substantial percentage of their stopping power in wet conditions. In fact, for the same braking force, the stopping power is typically about 50% of that in dry conditions.

Because humans have such limited power and endurance, the weight of bicycle components is important. Many prior art rim brakes are relatively heavy, especially when they include complex parallel pad mechanisms.

As the pads wear on prior art rim brakes, the position that the hand brake levers activate braking, changes. The more the pad wears, the closer the lever comes to bottoming out on the handle bar before activating braking action. The rider needs to make adjustments to the cable length in order to keep the lever in a preferred position.

Road bikes generally have caliper rim brakes instead of cantilever rim brakes. Because road bikes have relatively skinny tires as compared to mountain bikes, caliper rim brakes do not need to provide as much braking power. Road bike caliper rim brakes, however, suffer from most of the same problems as mountain bike rim brakes.

### SUMMARY OF THE INVENTION

The present invention is directed to a bicycle brake device which has extremely small brake pads, relatively hard pad rubber, and a tool-free pad adjustment mechanism that allows the rider to periodically extend the pad as it wears. Partially because of the small pad size, the brake can be designed to be very powerful, and simplify initial installation and adjustment, as well as offer other advantages.

An object of the present invention is to provide a bicycle rim brake, which is powerful. The formula for calculating friction between two sliding objects is simply:

F=uN Formula 1

where F is the force, u is the coefficient of friction between the two objects, and N is the normal force of one object on the other object.

Notably, the friction between two sliding objects is independent of the surface area of contact between the two objects. In other words, the braking friction between the brake pad and the rim is independent of the size of the pad. Therein is the fact that all prior art bicycle rim brakes seem to have ignored. Interestingly, the trend in bicycle rim brakes has been to make the brake pads increasingly bigger, as if this provides greater stopping power. Nothing could be further from the truth! The present bicycle brake device goes against this long tradition and instead uses a smaller brake pad contact area than has been used in prior art bicycle rim brakes. By choosing a relatively hard pad rubber with a relatively high coefficient of friction, the brake can actually be more powerful and offer many other advantages, as will be shown.

Another object of the present invention is to provide a bicycle rim brake which has a relatively small, hard brake pad. When the brake pad is relatively small, the force per unit area becomes relatively large. That is because when a force is applied to the brake pad, a small brake pad displaces that force over a smaller contact area. As braking forces per unit area increase, harder pad materials should be used or else the pad material will yield too much. As an example, the brake pads used for hydraulic car brakes are made from extremely hard organic or synthetic compounds. These hard organic or synthetic compounds combined with a high force per unit area provide ample braking power and are extremely durable even though they are stopping a vehicle weighing thousands of pounds.

Another object of the present invention is to provide a bicycle rim brake pad, which as a relatively small ratio of width to height. The height of pads is typically determined by the height of the rim. The present invention pad has a width to height ratio of only 1.4. Typically, prior art rim brake pads have a width to height ratio of between 4.0 and 7.0. In the present invention, a range of such ratios is contemplated to be 1.0 to 3.0.

Another object of the present invention is to provide a bicycle rim brake which has fewer degrees of freedom of adjustment in order to simplify installation and maintenance. The preferred embodiment has only four degrees of freedom of adjustment (arm angle via cable clamp, up/down, pad angle, and pad in/out) as compared to six of freedom for typical prior art rim brakes (arm angle via cable clamp, up/down, pad angle, pad rotation, pad orientation, pad in/out with spacers). The preferred embodiment can have only four degrees of freedom because the pad surface is so small that a pad rotation adjustment and pad orientation adjustment are unnecessary. Also, importantly, the preferred embodiment is designed so that the four degrees of freedom are independent. In typical prior art rim brakes, setup is difficult and it is nearly impossible to adjust both sides of the brake equally because typical prior art rim brakes have multiple adjustments that must occur simultaneously. Installing the preferred embodiment is substantially easier than setting up prior art rim brakes. In the preferred embodiment, the height (up/down) has a discrete number of positions such as four. This is so that the two degrees of freedom are separated (adjust the height and then the angle). That way the user can choose the position that is closest to correct and then twist the pad holder so that the pad is parallel to the rim braking surface and tighten the fastener. If necessary, final fine-tuning can be done by extending or retracting the pad slightly by twisting an adjustment knob by hand.

Another object of the present invention is to provide a bicycle rim brake which does not squeal or make other annoying noises during braking. Because the pads are so small and the pad holder structure is so rigid, squealing and other noises are much less likely to occur. It is not necessary to “toe in” the pads as is necessary with many prior art brakes.

Another object of the present invention is to provide a bicycle rim brake which maintains consistent pad/rim alignment, and maintains hand levers in the preferred position. With any brake, during use, the pad slowly wears. As it wears, the brake arms swing inward. The present invention, however, allows the user to easily extend the pads to their original preferred position without tools. This not only keeps the brake pad surface at the correct position relative to the rim, but also keeps the brake hand levers in the preferred position.

Another object of the present invention is to provide a bicycle rim brake which efficiently uses the pad material. Because the brake pad is small and deep and can easily be adjusted outward (rather than large and shallow like prior art pads), a large percentage of the pad is used during the life of the brake pad. In the preferred embodiment, over 75% of the total pad volume is useable. This means that either less rubber can be used for the same amount of useable rubber as prior art rim brakes but with less weight, or the same amount of rubber can be used as prior art rim brakes but much more of the rubber is useable.

Another object of the present invention is to provide a bicycle rim brake which has long lasting brake pads. The pads of this novel rim brake are made of relatively hard rubber because the small contact area means that the force per unit area is much higher than prior art rim brakes. Harder rubber means longer pad life. Also, as explained above, the majority of the pad volume can be used.

Another object of the present invention is to provide a bicycle rim brake which has easily replaceable pads without the use of tools. It is very easy to replace the pads on the rim brake of the present invention without using tools. To change the brake pads, the cable is released (a quick release well known in the prior art) which allows the brakes to swing open. Then one twists the pad position knob by hand until the pad holder extends to the end of the holder frame, fully exposing the worn pad. Then one twists out the worn pad by hand and twists in a new pad. The new pad is captured by the pad holder. One then retracts the pad into the holder frame by twisting the position knob. The same procedure for the other brake arm is then carried out.

Another object of,the present invention is to provide a bicycle rim brake which can be opened widely to allow the rider to easily remove and install bicycle wheels. There are many reasons that a rider needs to remove the wheel from the bicycle such as for repairing a punctured tube or replacing a tire or transporting the bicycle. The design of the inventive brake, including the small size of the brake pads, allows the brake to fully open without the brake pad holder interfering with the bicycle front or rear forks. This significantly eases the removal and installation of wheels, especially wheels with large inflated tires.

Another object of the present invention is to provide a bicycle rim brake which can be used on the front or rear of the bicycle. The design of this novel bicycle rim brake allows the brake to be mounted to the front or rear of the bike because the brake pads are held in a manner so that it does not matter which way the wheel is turning. This allows manufacturers, distributors, and retailers to carry a lower level of inventory because there is one brake model instead of two. Also, it inhibits consumers from installing the brakes improperly.

Another object of the present invention is to provide a bicycle rim brake which has powerful wet braking characteristics. The inventive bicycle rim brake is much less affected by a wet rim than prior art rim brakes. This is because the combination of the relatively high force per unit area of the small pads and the relatively hard rubber together cause the water that remains between the pad and the rim to be too thin to decrease friction.

Another object of the present invention is to provide a bicycle rim brake which weighs less. The present bicycle rim brake can be relatively light in weight due to the simple and efficient structure and choice of materials.

Another object of the present invention is to provide a bicycle rim brake which may be adapted to work on caliper rim brakes generally used on road bikes. Road bikes generally have caliper rim brakes instead of cantilever rim brakes. Because road bikes have relatively narrow tires as compared to mountain bikes, caliper rim brakes do not need to provide as much braking power. Road bike caliper rim brakes, however, suffer from most of the same problems as mountain bike rim brakes. In an alternative embodiment of this invention, the brake technology can easily be applied to a road biking caliper brake.

Another object of the present invention is to provide a bicycle rim brake which makes a parallel pad mechanism unnecessary. There are several brake mechanisms in the prior art that attempt to keep the pads of rim brakes relatively parallel to the wheel rim as the brake pad wears. However, these mechanisms invariably complicate the brake, add weight to the brake, add cost to the brake, and increase the chance to develop undesirable play between the pad and the rim. While a number of mechanisms could easily be made to keep the pad of the novel rim brake described herein parallel to the rim, it is wholly unnecessary because by periodically adjusting the exposed pad to its original length, the pad will remain relatively parallel to the rim anyway.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a front view of a preferred embodiment of a bicycle brake device according to the present invention showing it installed on a bicycle;

FIG. 2 is a side view of the front half of a bicycle with the preferred embodiment of a bicycle brake device according to the present invention;

FIG. 3 is a partially exploded view of the preferred embodiment of a bicycle brake device according to the present invention;

FIG. 4 is a front view of the preferred embodiment of a device according to the present invention showing it separated from a bicycle;

FIG. 5 is a cross sectional view of the device taken along line 5-5 in FIG. 4;

FIG. 6 is an enlarged front view of brake arm assembly of the preferred embodiment of a bicycle brake device according to the present invention.

FIG. 7 is perspective view of a typical prior art rim brake pad assembly with replaceable pad.

FIG. 8 is perspective view of the preferred embodiment of the pad assembly of a device according to the present invention.

FIG. 9 is a front view of a typical prior art brake hand lever with a brake wire, and a brake arm and pad assembly of a device according to the present invention;

FIG. 10 is a front view of the preferred embodiment of a device in an opened configuration according to the present invention.

### DETAILED DESCRIPTION OF A PREFERRED EMBODIMENT

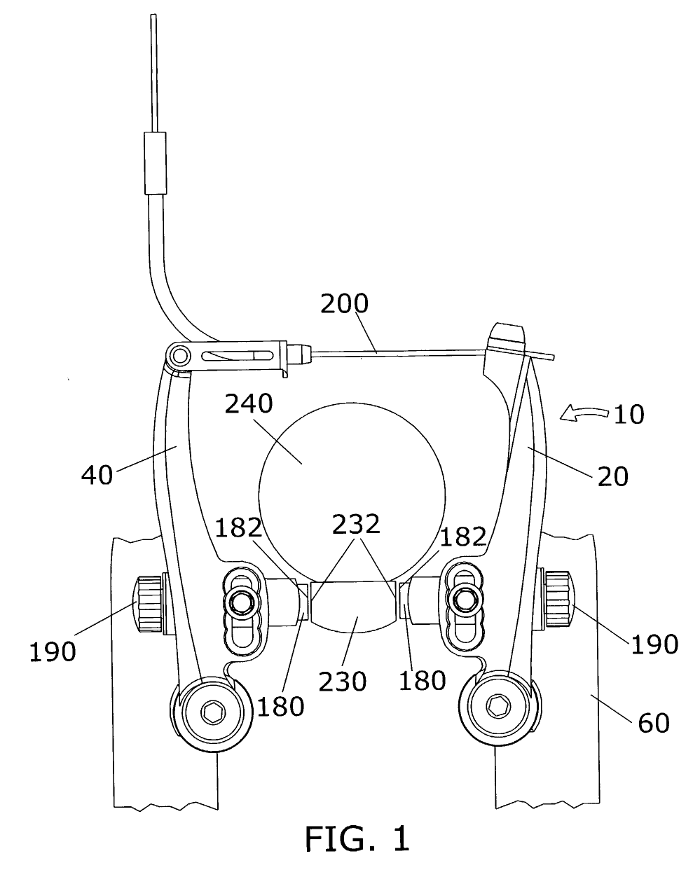

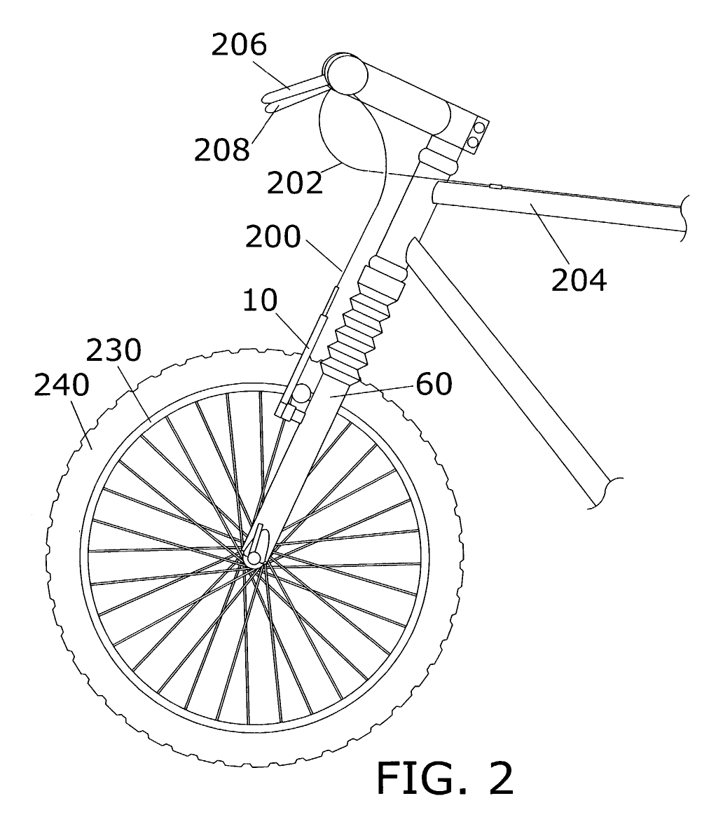

The bicycle brake mechanism 10 shown in FIG. 1, which comprises a preferred embodiment of the present invention, is (for example) a front wheel brake mechanism, and is supported at an intermediate point on the bicycle front fork 60 so that the mechanism is free to pivot. The brake mechanism 10 performs a braking action by pressing against both side surfaces 232 of the rim 230. The brake mechanism 10 is connected to the tip portion of a brake wire 200 which extends from a brake lever installed on the handlebar as is well known in the prior art. When the brake lever (206 in FIG. 2) is pulled by the user, wire 200 causes levers 20 and 40 to be pulled together so that surfaces 182 of brake pads 180 contact surfaces 232 of rim 230. Arms 20 and 40 are contoured to provide sufficient clearance around tire 240. Each adjustment knob 190 can be turned to extend or retract brake pad 180 in order to fine tune the gap between surface 182 and 232 and compensate for pad wear.

As shown in FIG. 2, the brake mechanism 10 is mounted to the front fork 60 of a bicycle. The tire 240 is mounted to a rim 230, which is connected to the fork 60. The fork 60 is connected to the frame 204. There is a brake hand lever 206 with a wire 200 connected to the brake 10. There is a brake hand lever 208 with a wire 202 that is routed towards the rear of the bike (to connect to the rear rim brake). Note that the wire sheaths are not shown around the wires 200 and 202.

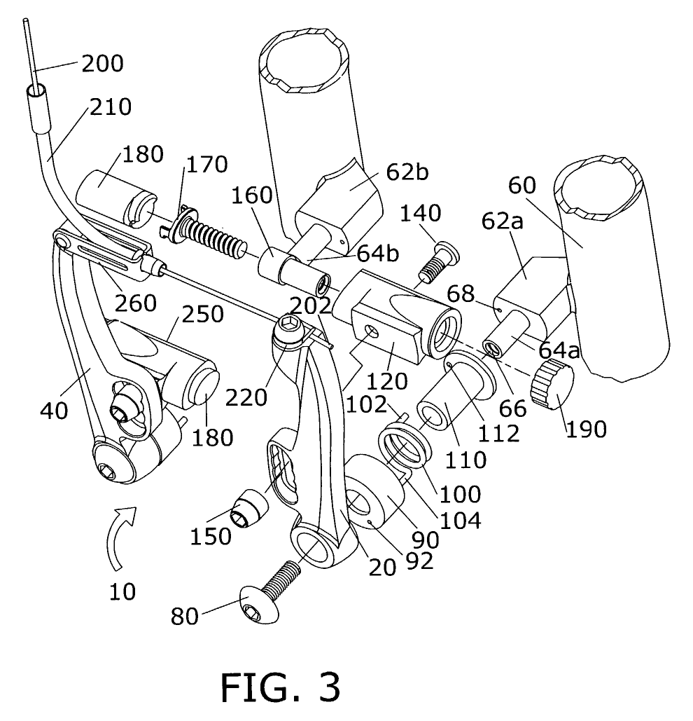

As is shown in FIG. 3, this brake mechanism 10 has a brake arm 20 which is fastened to the tip end of the inner wire 202 of the brake wire 200 via a connector 220, and a brake arm 40 which is installed so that it contacts the sleeve 210 via a cable hanger 260. Brake pads 180 can be extended and retracted by turning the adjustment knobs 190. The gap between the brake pads 180 and the side surfaces of the wheel rim 232 may be adjusted by adjusting the fastening position at the tip of the inner wire 200 within the connector 220 and/or by turning the adjustment knob 190.

Each pad assembly 250 is comprised of a pad 180, a plunger 170, a plunger fitting 160, a housing 120, an adjustment knob 190, and housing screw 140. A nut 150 secures the pad assembly 250 to the arm 20 or 40. The pad 180 has a relatively small surface area for contacting the rim 230 so that the pad 180 provides a high force per unit area and so that the pad 180 does not interfere with the fork 60 when arms 20 and 40 are opened to remove or install the wheel. Preferably, housing 120, plunger 180, and knob 190 are made of a light but strong material such as aluminum or magnesium.

Both brake arms 20 and 40 are constructed so that they are more or less symmetrical with respect to the left-right direction, and the intermediate parts of the brake arms (with respect to the vertical direction) are bent outward in a convex bow shape. Preferably, arms 20 and 40 are made of a light but strong material such as aluminum or magnesium. The lower end portions of the brake arms 20 and 40 are supported by fastening pins 64a and 64b so that the lower end portions are free to pivot. As used herein, the terms “upper,” “lower,” “inner,” and “outer” are to be interpreted as viewed in FIG. 1. The fastening pins 64a and 64b protrude forward from seats 62a and 62b, which are respectively soldered to intermediate portions of the front fork 60.

A spring 100 has an end 104 that fits through hole 92 of spring housing 90 into a hole in the back of brake arm 20. End 102 of spring 100 fits through hole 112 of bushing 110 into retaining hole 68. This spring mechanism is well known in the prior art. The spring mechanism shown is in a simplistic form, but, as is well known in the prior art, the spring mechanism can easily be designed to allow tension adjustment.

Attachment bolts 80 are fastened to the ends of the fastening pins 64a and 64b. These attachment bolts 80 are used to regulate the movement of the brake arms 20 and 40 in the axial direction.

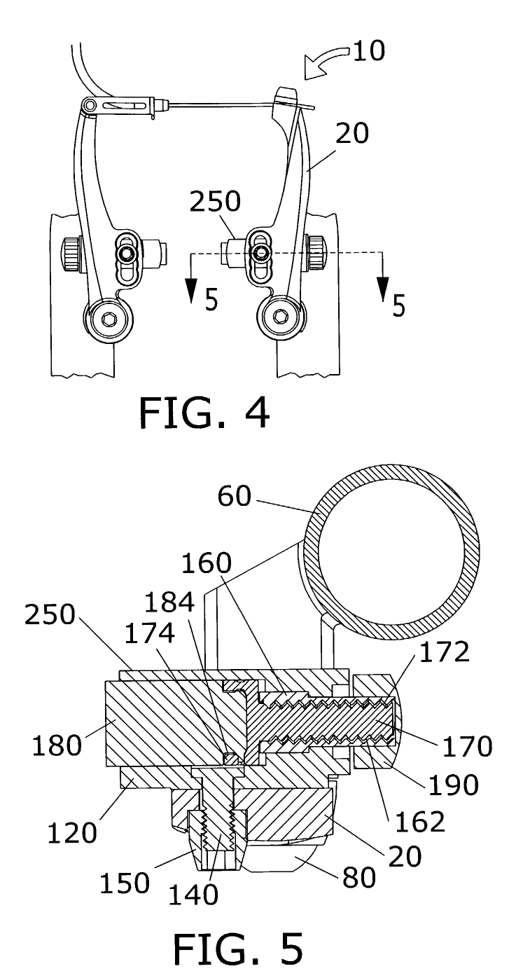

FIG. 4 provides a view of the brake mechanism 10 separate from a bicycle and there is a section line 5-5 taken through pad assembly 250 and arm 20 of the brake 10. The sectional view along lines 5-5 is shown in FIG. 5.

As shown in FIG. 5, the pad assembly 250 has a mechanism that allows the pad 180 to be extended and retracted by twisting the adjustment knob 190. In this embodiment, the pad 180 has an elliptical cross section (as seen in FIG. 3). This elliptical cross section prevents the pad 180 and the plunger 170 from rotating inside the pad housing 120. The plunger 170 has a hook 174 to secure the pad 180 the plunger via a groove 184 on the pad 180. In the preferred embodiment, the plunger 170 and the fitting 160 have left-handed threads 172 and 162, respectively. The adjustment knob 190 is fixed to the fitting 160 via a press fit, adhesive, or other appropriate attachment means. When adjustment knob 190 is turned clockwise, the plunger 170 is forced outwards. Conversely, when adjustment knob 190 is turned counter-clockwise, the plunger 170 is forced inwards. The pad assembly 250 is secured to arm 20 by the screw 140 and nut 150. Arm 20 is secured to fork 60 by screw 80.

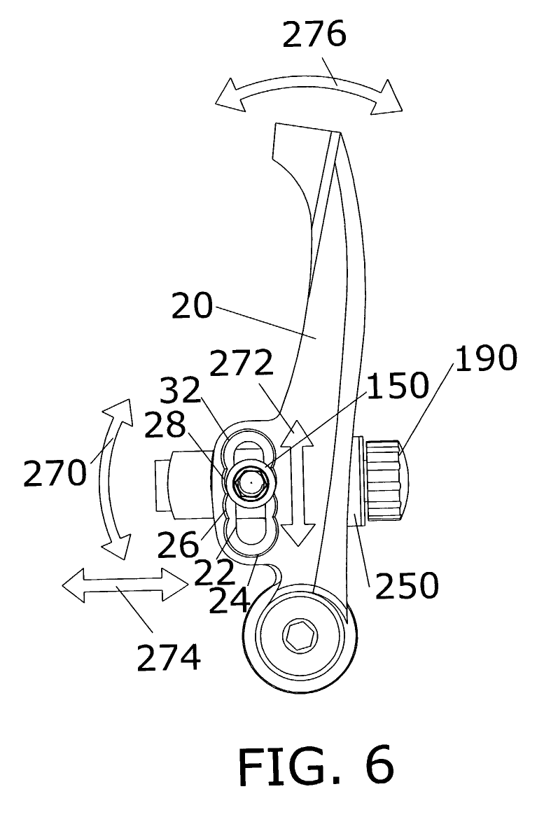

As shown in FIG. 6, the brake assembly has four means of adjustment during brake setup. The adjustments are necessary because rims can vary in width from one brand or model to another, the distance between fastening pins 64a and 64b can vary from one fork or frame to another, as well as the relative position between fastening pins 64a and 64b, and the brake rim can vary from one fork or frame to another. As has been previously described, gross angular adjustment 276 is accomplished by adjusting brake cable 200 in connector 220. There is a slot 22 to allow vertical adjustment 272. Slot 22 has four scalloped contours 24, 26, 28, and 32 that accept the nut 150 in any of the four positions. The discrete positions simplify initial brake installation by limiting the degrees of freedom of adjustment and making it easier to set up the brake arms 20 and 40 symmetrically. Before nut 150 is tightened, the pad assembly 250 can twist to allow angular adjustment 270. Turning adjustment knob 190 allows the pad to extend out and in along direction 274.

During installation, ideally, the brake is set up so that the pads are relatively close to the rim and when the brake wire is pulled, the pads will touch the rim with the brake pad surface flat against the rim. Generally, the brake would be installed by first setting the gross angular adjustment 276 via the brake cable. Then the user would choose to place nut 150 into the scalloped contour 24, 26, 28, or 32 that appears to be closest to correct. Then nut 150 is tightened just enough so that the pad assembly 250 can still be twisted to adjust angle 270 to allow the user to properly position the brake pad. If necessary, a different scalloped contour can be chosen by loosening nut 150 sufficiently. When the pad surface is in the proper position, the brake is set up. If necessary, fine tuning can be achieved by twisting the adjustment knob 190. However, the primary purpose of being able to adjust pad 180 in the direction 274 is to easily compensate for pad wear. Compensating for pad wear in this way does three important things:

1. It ensures that the pad 180 continues to contact parallel to rim surface 232. Prior art mechanisms intended to keep the pad parallel to the rim are often complex, and can cause play to develop with use.

2. It ensures that pad 180 continues to contact surface 232 at the same height. Most prior art rim brakes, including those that have parallel pad mechanisms, allow the pad to arc down below the rim surface as the pad wears. The problem for prior art brakes with parallel pad mechanisms is exacerbated after wear causes play to occur in the mechanism.

3. It ensures that the distance between the rim surface 232 and the pad 180 remains relatively constant, which means that the distance the brake lever 206 travels prior to causing braking actions remains constant. This is an important feature to riders that typically have a strong preference in how far they pull the brake handle prior to activation. For example, some riders prefer the braking action to begin after very little lever pull and other riders prefer that the braking action begins only after the handle is pulled through half the total possible lever motion.

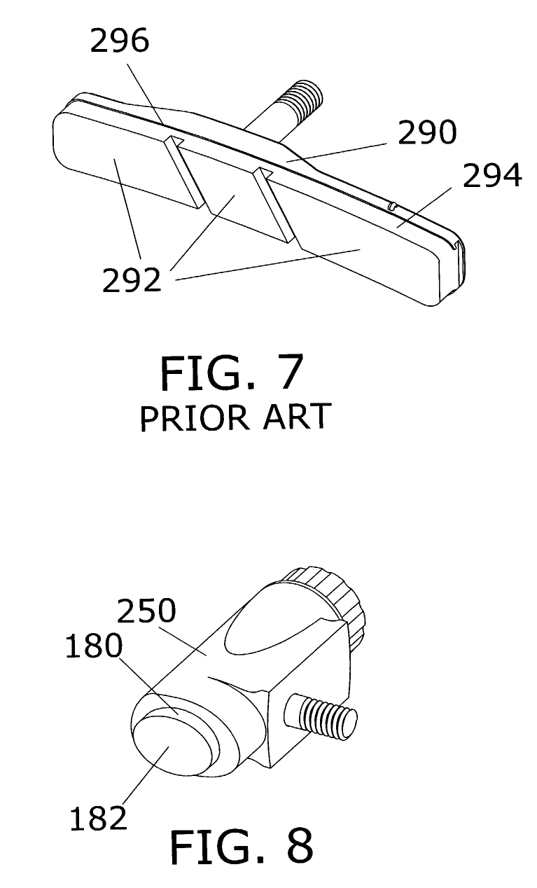

As shown in FIG. 7, a typical prior art rim brake pad assembly 290 has a replaceable pad 294 with a braking surface 292. This particular prior art pad 294 has the following characteristics:

1. The braking surface 292 of the pad assembly shown has a surface area of 686 square millimeters.

2. This brake pad assembly 290 has 1372 cubic mm of useable pad if pad 294 is worn until there is only 2 mm of thickness remaining between pad surface 292 and the edge of the pad support 296.

3. The total volume of pad 292 is 4374 cubic mm, which means that only about 31% of the total pad volume is useable.

4. Pads of differing hardnesses are available for differing riding conditions. Typically, pads intended for dry riding conditions are in the Shore 78A to 82A hardness range. Pads intended for wet and muddy riding conditions are in the 86A to 90A hardness range. Pads intended for a combination of dry and wet riding conditions are typically in the shore 82A to 86A hardness range. Harder pads wear longer given the same braking conditions.

5. The width of pad 294 is 70.5 mm and the height is 10.3 mm. Therefore, the width to height ratio is about 6.8. As previously stated, typical prior art brake pads have a width to height ratio of between 4.0 and 7.0. The height of 10.3 mm is slightly less than typical wheel rims, which have a height of about 10.7 mm.

FIG. 8 is perspective view of a pad assembly of a bicycle brake device according to a preferred embodiment of the present invention. The preferred pad 180 has the following characteristics:

1. The pad assembly 250 has a pad 180 with a braking surface 182 with a braking surface area of 117 square millimeters.

2. The brake pad assembly 250 has 2071 cubic mm of useable pad if pad 180 is worn until there is only 2 mm of thickness remaining between pad surface 182 and the pad plunger 170 (best shown in FIG. 5).

3. The total volume of pad 180 is 2721 cubic mm, which means that over 76% of the total pad volume is useable. There is about 51% more useable pad in the embodiment shown than in the prior art embodiment (2071 cubic mm versus 1372 cubic mm).

4. Additionally, pad 180 is significantly harder than pad 294. This higher hardness combined with the larger useable volume means that pad 180 will last about twice as long as the prior art pad 292. Because the pad surface area is relatively small, the pad rubber is hard relative to prior art brake pads. Ideally, the brake pad hardness would be between shore 95A and 75D depending on the actual size of surface 182 and riding conditions. There is a significant difference in hardness for every few Shore points.

5. The width of pad 180 is 14.5 mm and the height is 10.3 mm. Therefore, the width to height ratio is about 1.4, which is significantly less than all prior art rim brake pads.

6. The shape of pad 180 is an oval in order to maximize the pad size within a small envelope while still consistently fitting the wide variety of different bicycles that have different relationships between the fastening pins 64a and 64b and rims 230. Because of the oval shape (compared to a rectangle), the pad will still make full contact with the rim surface 232 even if the pad is slightly rotated relative to the rim. Also, because the pad 180 is a non-round shape, it resists turning while the adjustment knob 190 is turned. It will be understood that other shapes including round shape, are also contemplated herein.

Pad housing 120 supports pad 180 equally in both braking directions. In other words, brake 10 can be mounted to the front or rear of the bike because the brake pads are held such that it does not matter which way the wheel is turning. This allows manufacturers, distributors, and retailers to carry a lower level of inventory because there is one brake model instead of two. Also, it inhibits consumers from installing the brakes improperly, and gives consumers more flexibility in where they can use the brake. Prior art brake using pad holders similar to prior art pad assembly 290 can only be used in one direction without risking that pad 292 inadvertently slides out of the assembly. Prior art bicycle rim brakes with such pad holders are assembled to be either front or rear brakes.

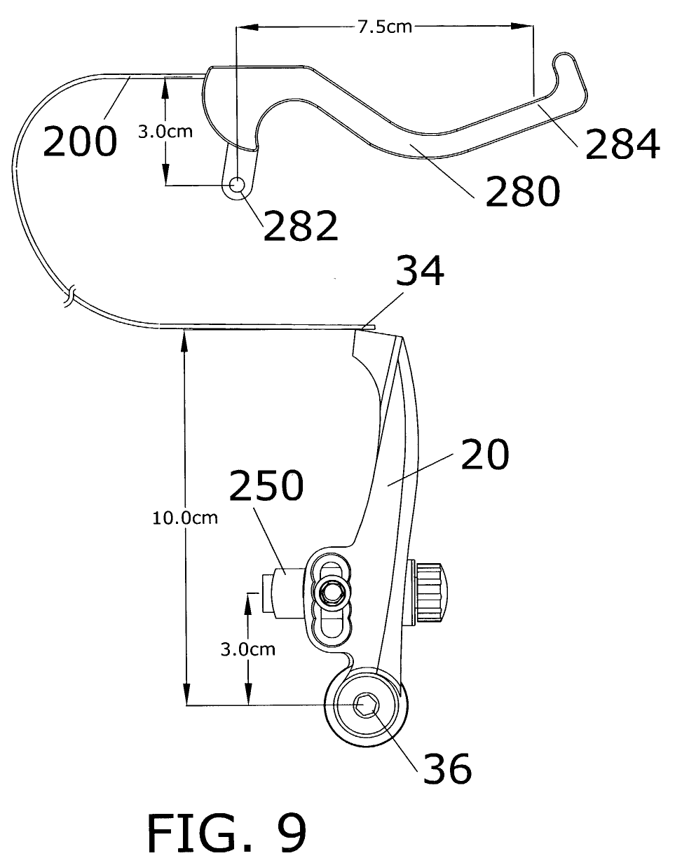

FIG. 9 is a front view of a typical prior art brake hand lever 280 with a brake wire 200, and a brake arm 20 and pad assembly 250 of a bicycle brake device according to the present invention. The user typically pulls on the brake arm at point 284 with a finger. Point 284 is about 7.5 cm away from the pivot point 282. The brake wire 200 is approximately 3 cm away from pivot point 282. Point 34 is about 10 cm away from pivot point 36. The pad assembly 250 is about 3 cm away from pivot 36. Using these figures, the force applied to rim 230 by pad 180 is as follows:

F(wire)=F(hand)×7.5 cm/3 cm Formula 2

F(pad)=F(wire)×10 cm/3 cm Formula 3

Therefore,

F(pad)=25×F(hand). Formula 4

As an example, if the Force applied by the user's hand is 5000 g, then the F(pad)=125,000 g. The pad force is the same as the Normal force in friction Formula 1.

The prior art pad shown in FIG. 7 has a braking surface area of 686 square mm. Therefore, for a pad force of 125,000 g, there is a force per unit area of 182 g per square mm applied to the brake pad surface (125,000 g/686 square mm).

Compare this to the pad 180 shown in FIG. 8, which has a braking surface area of only 117 square mm. Therefore, for a pad force of 125,000 g, there is a force per unit area of 1068 g per square mm applied to the brake pad surface (125,000 g/117 square mm).

Therefore, the pad force per unit area for the brake pad disclosed for this invention is 5.87 times greater than the prior art brake pad (1068/182), or approximately ⅙^{th} the size of the prior art brake pad 294 shown in FIG. 7. At 117 square mm, the pad 180 shown in FIG. 8 is less than ½ the size of any prior art bicycle brake pad known to the invention.

Referring to Formula 1 (F=uN), the normal force (N) is the same as the pad force. For the brake system shown in FIG. 9, the normal force is pad force as shown in Formula 3. Under certain conditions, the friction between two sliding objects is independent of the surface area of contact between the two objects and is, instead, dependent only on the normal force (pad force) multiplied by the coefficient of friction.

The coefficient of friction for some rubber compounds increases as the Shore hardness increases. That means that the braking force should increase for harder brake pads. However, Formula 1 is only correct for relatively compressible materials such as rubber when the force per unit area is in an appropriate range for a particular Shore hardness. If the force per unit area is too low, then the friction will be less than Formula 1 would predict. For example, very hard rubber will slide easily across an aluminum surface with a low force per unit area whereas a soft rubber under the same normal force would not slide as easily. If the force per unit area is too high, then the rubber will distort too much, and on a bicycle brake system, it will provide a sponge-like feeling. In fact, the brake pad could be so soft that even with the full travel of the brake handle lever, the pad force would remain insufficiently low because the pad rubber would excessively distort. By making pads 180 out of rubber that is at least Shore 95A in hardness, the braking power is exceptional for brake 10.

An advantage of the brake 10 is that it retains superior braking power in wet conditions. Prior art rim brakes suffer substantial power loss when wet (up to 50%), whereas the brake 10's small pad size combined with the harder pad rubber cause little or no loss in braking power. The improvement in performance between the brake 10 and prior art rim brakes can be explained as follows: Prior art rim brakes have a relatively low force per unit area (182 grams per square mm for a typical brake as explained above). This low force per unit area allows enough of a film of water to remain between the rim surface 232 and pad surface 292 that braking friction is substantially reduced because the water film easily shears past itself. As a comparison, consider that a car with tires pressurized at 32 pounds per square inch only apply a force of about 28 grams per square mm to the road (assuming the tire has a tread that is 80% rubber where it contacts the road). The risk of dangerous hydroplaning (sliding on water) with a car is well known. Conversely, the brake 10 has a relatively high force per unit area (1068 grams per square mm as explained above), which is 38 times greater than a car tire at 32 psi and almost 6 times greater than prior art bicycle rim brakes. The force per unit area is so high that a film of water between the rim 232 and pad surface 182 is too thin to cause substantially reduced friction. Water itself is not a good lubricant unless it has a thick enough film to easily shear.

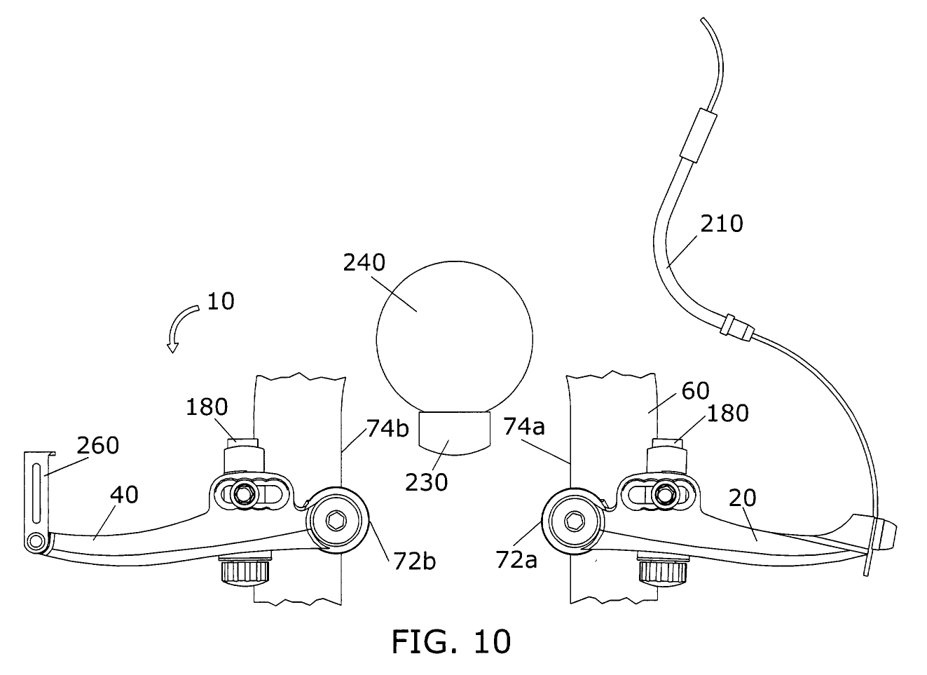

As shown in FIG. 10, sleeve 210 has been removed from cable hanger 260 as is well known in the prior art. This allows arms 20 and 40 to open to allow removal or installation of the wheel that includes rim 230 and tire 240. It is important to note that arms 20 and 40 are opened far enough so that the pads 180 do not interfere with the tire 240 during removal or installation. In prior art brakes, the pads are so wide that they cannot swing past surfaces 74a and 74b of fork 60 when the arms are opened. For most front and rear fork configurations, the prior art brake pads reduce the amount of room for the tire to be removed or installed. Brake 10, conversely, has pads 180 that are sufficiently small as to allow arms 20 and 40 to swing completely open. This significantly eases the removal and installation of wheels, especially wheels with large inflated tires. This is a significant advantage to riders over prior art rim brakes. There are many reasons that a rider needs to remove the wheel from the bicycle such as for repairing a punctured tube or replacing a tire or transporting the bicycle. The smallest clearance for the tire to pass is the distance between surfaces 72a and 72b instead of between the brake pads. The distance between surfaces 72a and 72b varies to a small degree from one bicycle to another whereas the distance between surfaces 74a and 74b varies greatly because it depends on the front or rear fork design.

Replacing pads 180 is also much easier than replacing pads on prior art brakes. To replace pads 180 on brake 10, arms 20 and 40 are opened as described above. To replace pads 180, the rider simply extends pad 180 by twisting knob 190 clockwise to the position that pad 180 can be twisted out of engagement with plunger 170. The replacement pad 180 can then be twisted into engagement with plunger 170 and then pad 180 is retracted into the desired position by twisting knob 190 counter-clockwise. Note that the pad 180 replacement is accomplished without the use of any tools.

Alternative Embodiments

Those skilled in the art will now readily perceive other embodiments. For example, the inventive brake technology could easily be applied to caliper rim brakes instead of cantilever rim brakes. Caliper rim brakes are generally used for road bikes rather than mountain bikes. Because road bikes have relatively narrow tires as compared to mountain bikes, caliper rim brakes do not need to provide as much braking power. Road bike caliper rim brakes, however, suffer from most of the same problems as mountain bike rim brakes and would benefit from most of the advantages of this novel brake technology.

While there are many advantages to making pad 180 adjustable via knob 190, there are still significant advantages to an even more simple embodiment using this technology that has no pad extension adjustment. Because the pad is relatively hard, even a non-adjustable pad would last for a reasonable length of time, and would weigh less and cost less to manufacture. For example, even without the pad extension adjustment feature, the brake could still have the following advantages over prior art rim brakes: Easy set up, improved braking power, brake arms that open completely for easy wheel removal and installation, low weight, and improved wet braking power.

It will also be understood that there are many different mechanisms that could extend and retract the brake pad. The pad could also be extended and retracted with a tool instead of by hand.

This novel brake technology could also include a parallel mechanism that would ensure that the pad 180 remains parallel to rim surface 232 even before the pad is adjusted with knob 190.

The pad assembly 250 could have a simple mechanism to cause a “clicking” sound and feel when knob 190 is turned. The “clicking” would ensure that knob 190 does not inadvertently turn via vibration, and would give the rider a sense of how far they have adjusted pad 190 (for example, 3 clicks with each knob 190 so that pad assemblies 250 on arms 20 and 40 remain symmetric).

The spring could be adjustable in order to fine tune the spring tension and assure that both pads 180 contact the rim 230 simultaneously. In fact, most rim brake springs are adjustable for these reasons. Mechanisms to adjust the springs in bicycle rim brakes are well known in the prior art. Another example is that the spring shown in the preferred embodiment is a round coil spring, but it could easily instead be a cantilever spring as is well known in the prior art of bicycle rim brakes.

The four contours 24, 26, 28, and 32 could instead be any other number of contours or be eliminated completely so that the pad assembly 250 could be adjusted more finely.

If pad 180 is made of a softer rubber compound such as shore 90A, then the brake becomes less powerful and has a “sponge-like” feel as previously described. However, for certain riders, this is an advantage because it can act as an “anti-lock” system. Some recreational riders do not desire high braking power and instead prefer a brake that cannot inadvertently lock-up and cause a crash. There are mechanisms in the prior art that accomplish this feature through the use of springs. However, because the preferred embodiment has a pad 180 that is relatively long, a softer pad 180 itself can act as a spring that prevents wheel lock-up.

It will thus be evident that there are many additional embodiments which are not illustrated above but which are clearly within the scope and spirit of the present invention. The above description and drawings are therefore intended to be exemplary only and the scope of the invention is to be limited solely by the appended claims and their equivalents.

We claim:

1. A bicycle brake comprising:
a pair of opposed arms connected through a cable to respond simultaneously to activation of a lever by forcibly extending toward the outer rim surface of a bicycle wheel; and
a pair of brake pads respectively mounted to said opposed arms for frictionally engaging said outer rim surfaces upon said lever activation;
each said brake pad being substantially elongated and cylindrical in shape and being retained in a housing that is affixed to a respective one of said arms.

2. The bicycle brake recited in claim 1 wherein each said pad has a substantially round cross-section.

3. The bicycle brake recited in claim 1 wherein each said pad has a substantially oval cross-section.

4. The bicycle brake recited in claim 1 wherein each said pad is elongated along an axis that is substantially perpendicular to a respective one of rim surfaces.

5. The bicycle brake recited in claim 1 wherein each said pad is adjustable within said housing along a direction that is substantially perpendicular to a respective one of said rim surfaces.

6. The bicycle brake recited in claim 1 further comprising a translatable plunger contained in each said housing and configured for receiving a pad, said plunger being adjustable for selectively translating the pad for extending and retracting the pad relative to the housing.

7. The bicycle brake recited in claim 1 wherein each said pad has a rim contacting surface and wherein the Shore hardness of said contacting surface is in the range of 95A to 75D.

8. The bicycle brake recited in claim 1 wherein each said pad has a height and a width and wherein the ratio of width to height is less than 3.0.

9. The bicycle brake recited in claim 1 wherein each said pad has a contact surface and wherein the area of said contact surface is less than 200 mm squared.

10. The bicycle brake recited in claim 1 wherein each said housing is adjustable in position along a respective one of said arms.

11. In a bicycle brake having a pivotable arm and a brake pad affixed to the arm for selectively engaging the rim of a wheel; an improved brake pad assembly comprising:
a brake pad having an elongated shape with an axis substantially perpendicular to a respective one of said rim surfaces; and
a housing receiving at least a first portion of said brake pad and exposing a second portion of said brake pad, said second portion terminating in a wheel rim engaging surface.

12. The improvement recited in claim 11 further comprising a pad translation device within said housing and retaining said brake pad, said translation device being adjustable for translating said brake pad relative to said housing.

13. The improvement recited in claim 11 wherein said wheel rim engaging surface is substantially round in cross-section.

14. The improvement recited in claim 11 wherein said wheel rim engaging surface is substantially elliptical in cross-section, having a major axis and a minor axis.

15. The improvement recited in claim 14 wherein the ratio of length of said major and minor axes is less than 3.0.

16. The improvement recited in claim 11 wherein said brake pad is made of a material having a Shore hardness in the range of about 95A to about 75D.

17. The improvement recited in claim 11 wherein said wheel rim engaging surface has a surface area which is less than about 200 mm².

18. A bicycle brake comprising:
a pair of opposed arms connected through a cable to respond simultaneously to activation of a lever by forcibly extending toward the outer rim surface of a bicycle wheel; and
a pair of brake pads respectively mounted to said opposed arms for frictionally engaging said outer rim surfaces upon said lever activation;
each said brake pad having a height and a width wherein the ratio of width to height is less than 3.0.

19. The bicycle brake recited in claim 18 wherein the area of said contact surface is less than 200 mm².

20. The bicycle brake recited in claim 18 wherein each said brake pad has a rim contacting surface and wherein the Shore hardness of said contacting surface is in the range of 95A to 75D.

21. A bicycle brake comprising:
a pair of opposed arms connected through a cable to respond simultaneously to activation of a lever by forcibly extending toward the outer rim surface of a bicycle wheel; and
wherein each said arm has a vertical slot for adjusting the height of said pad;
wherein each said slot has a plurality of scalloped contours for supporting said pad in a plurality of discrete positions.
